(19) United States
(12) Patent Application Publication
(10) Pub. No.: US 2015/0375427 A1
(43) Pub. Date: Dec. 31, 2015

(54) Angled-Mold Core Actuating Mechanism

(71) Applicant: Heng Man HOONG, Singapore (SG)

(72) Inventor: Heng Man HOONG, Singapore (SG)

(21) Appl. No.: 14/768,453

(22) PCT Filed: Feb. 18, 2013
(86) PCT No.: PCT/SG2013/000062

§ 371 Date: Aug. 17, 2015

(51) Int. Cl. B29C 37/00; B29C 31/00

(52) U.S. Cl. CPC B29C 37/001; B29C 31/008; B29L 2031/737

(57) ABSTRACT

The present invention provides an angled-mold core actuator (180, 280, 380). When actuated, an angled-cavity forming core (158) is extended into a mold cavity defined by a mold insert (154). The angled-cavity forming core (158) is disposed at a 3-dimensional angle into the mold insert (154) to form a cavity (104) in a molded product. The angled-cavity forming core is actuated by a driven pin (186, 286, 386) of the angled-mold core actuator (180, 280, 380).

### FIELD OF INVENTION

The present invention relates to injection or compression molding, and more particularly to an angled-mold core actuating mechanism for use with injection or compression molding.

### BACKGROUND

Injection or compression molding is a common manufacturing process used to produce plastic products, especially those that have fine or intricate shapes and finishing. In the process, molten thermoplastic or thermosetting plastic material is injected or transferred into a mold cavity and after allowing the molten materials to cool and at least partially harden to take on the shape of the mold cavity, the mold plates that define the mold cavity are opened to release a molded product. When an angled-feature (such as, a groove, a projection, a thread or hollow cavity) is formed in the molded product, the moveable-mold half is prevented from being moved away from the stationary-mold half or the molded product is prevented from being released from the moveable- or stationary-mold half. For example, when an angled-cavity is to be formed in the molded product, a mold core positioned at an angle must moveably extend into the mold cavity during the molding process for the molten material to take the shape of the product and cavity, to cool and solidify sufficiently before the mold core is retracted and mold plates are opened for the molded product to be removed. As the mold core is at an angle (that is, the angled-feature is not aligned along the planes of opening of the relevant mold plates), the angled-cavity mold core must be retracted before the relevant mold plates can be opened.

A conventional mold core drive or actuating mechanism uses a system of cams and slides, often together with a fluid actuator system. Such a conventional system is complicated, thus making it difficult to assemble and difficult to reconfigure; often it becomes unreliable or difficult to maintain, for example, due to accumulated deviations and tolerances, and invariably costly to make. The size of such a conventional mold core drive mechanism also makes it difficult to be arranged on a mold assembly to manufacture a small plastic product with an angled-feature, such as, an inkjet cartridge housing having slanting internal cavities. There is, therefore, a need to provide an angled-mold core drive mechanism that is simple in structure, compact in size and easy to assemble and maintain.

### SUMMARY

The following presents a simplified summary to provide a basic understanding of the present invention. This summary is not an extensive overview of the invention, and is not intended to identify key features of the invention. Rather, it is to present some of the inventive concepts of this invention in a generalised form as a prelude to the detailed description that is to follow.

The present invention seeks to provide a linear and axial motion transfer actuator 180, 280, 380. An advantage of the linear and axial transfer actuator is its simple structure for transferring a linear motion along a first axis to a linear motion inclined at an angle to the first axis. This motion transfer actuator is useful for driving a core 158 to form a cavity 104 that is orientated in a 3-dimensional angle during molding of a product.

In one embodiment, the present invention provides a linear and axial motion transfer apparatus comprising: an actuator body having two bores disposed axially at an angle to each other; a drive pin and a driven pin separately disposed in the two bores so that the drive and driven pins are slidably guided for reciprocation in the respective bores; and a channel for communicating between the two bores, with the channel being filled with an incompressible material so that when the drive pin is axially displaced, displacement of the drive pin is transmitted axially to the driven pin.

Preferably, a portion of the drive or driven pin disposed inside the actuator body has a longitudinal flat formed parallel to the longitudinal axis of the pin to cooperate with a stopper pin to prevent the pin from being inadvertently displaced out of the actuator body.

Preferably, the incompressible material comprises a series of metal balls, oil or grease.

Preferably, a free end of the driven pin is configured as a cavity forming core in association with a mold insert that defines a mold cavity. Preferably, the cavity forming core is separate from the driven pin such that an end of the cavity forming core adjacent the driven pin is journaled in a holder and the holder is operable to slide with respect to the mold insert.

In another embodiment, the present invention provides a method for forming a molded product having cavity disposed at a 3-dimensional angle. The method comprises: transferring translation of a drive pin to a driven pin, wherein the drive and driven pins are disposed at an angle to each other; actuating the driven pin to drive an angled-cavity forming core into a mold cavity, wherein the angled-cavity forming core is disposed at a 3-dimensional angle in the mold cavity; filling the mold cavity with a molten compound and allowing the molten compound to cool and to solidify for it to take the shape of the mold cavity and angled-cavity forming core; and retracting the angled-cavity forming core and then opening the mold supporting the mold insert, which defines the mold cavity, to release a molded product.

In yet another embodiment, the present invention provides an insert molding method. The insert molding method comprises: transferring translation of a drive pin to a driven pin of the angled-motion transfer apparatus according to any one of claims 1-13; actuating the driven pin to place an insert, which is disposed at an end of an angled-cavity forming core, into a mold cavity, wherein the angled-cavity forming core is disposed at a 3-dimensional angle in the mold cavity; filling the mold cavity with a molten compound in a first molding step and allowing the molten compound to cool and to solidify for it to take the shape of the mold cavity and to support the insert; releasing the insert from the end of the angled-cavity forming core and then retracting the angled-cavity forming core; filling the cavity created by the retracted angled-cavity forming core with a molten compound in a second molding step and allowing the molten compounds to cool and harden; and opening the mold supporting the mold insert to release a molded product.

### BRIEF DESCRIPTION OF THE DRAWINGS

This invention will be described by way of non-limiting embodiments of the present invention, with reference to the accompanying drawings, in which:

FIGS. 1A and 1B illustrate a section of a mold for forming a product with an angled-mold core drive mechanism according to an embodiment of the present invention, where the mold shown in FIG. 1A is in an open position and the mold shown in FIG. 1B is closed;

FIG. 2 illustrates a plan view of a lower half of the mold shown in FIG. 1A or 1B with the mold core being positioned at a 3-dimensional angle to the molding opening plane but with only one molding station being shown;

FIG. 3A illustrates a perspective view of the angled-mold core drive mechanism shown in FIGS. 1A, 1B and 2, whilst FIG. 3B illustrates an explode view;

FIG. 4. illustrates an angled-mold core drive mechanism according to a variation of the embodiment shown in FIG. 1A; and

FIGS. 5A and 5B illustrate sections of two angled-mold core drive mechanisms according to yet other embodiments of the present invention.

### DETAILED DESCRIPTION

One or more specific and alternative embodiments of the present invention will now be described with reference to the attached drawings. It shall be apparent to one skilled in the art, however, that this invention may be practised without such specific details. Some of the details may not be described at length so as not to obscure the invention. For ease of reference, common reference numerals or series of numerals will be used throughout the figures when referring to the same or similar features common to the figures.

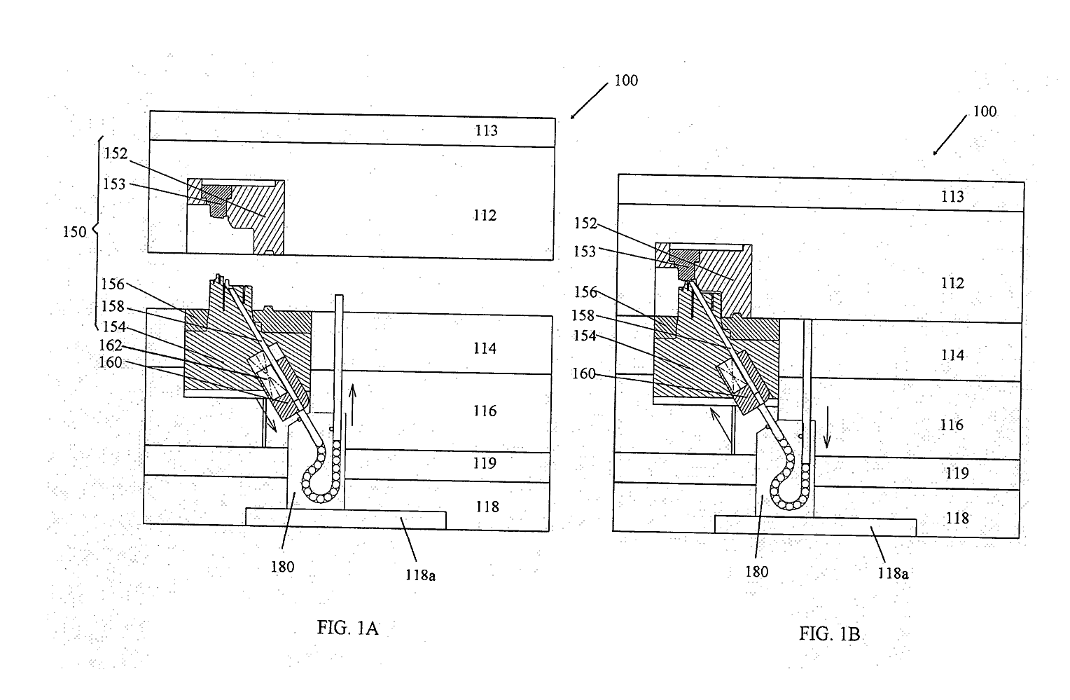

FIGS. 1A and 1B show a sectional view of a mold 100 for forming a product 102 (not shown in the figure) with an angled-cavity 104 according to an embodiment of the present invention. In FIG. 1A, the mold 100 is shown in an open position, where the upper and lower halves are separated for the molded product to be released and an angled-cavity forming core 158 is retracted, whilst FIG. 1B shows the mold in the closed position with the cavity forming core 158 being extended. As shown in FIG. 1A or 1B, the mold 100 comprises a series of mold plates, such as, a cavity plate 112, a stripper plate 114, a core plate 116 and a back plate 118. In addition, a molding insert 150 disposed in the mold 100 also comprises a series of components, such as, a cavity insert 152, which defines an external surface of the molded product; a core insert 154, which defines an internal surface of the molded product; a stripper insert 156 to help release the product 102 after being molded; and the angled-cavity forming core 158, which is used to form the angled-cavity 104 in the molded product. Depending on the design, such as, for ease of machining or design change, the mold 100 and the molding insert 150 may comprise of additional components; for example, the cavity plate 112 may be mounted on a manifold plate 113, or the back plate 118 may comprise a spacer plate 119. In another example, the cavity insert 152 may comprise a cavity sub-insert 153.

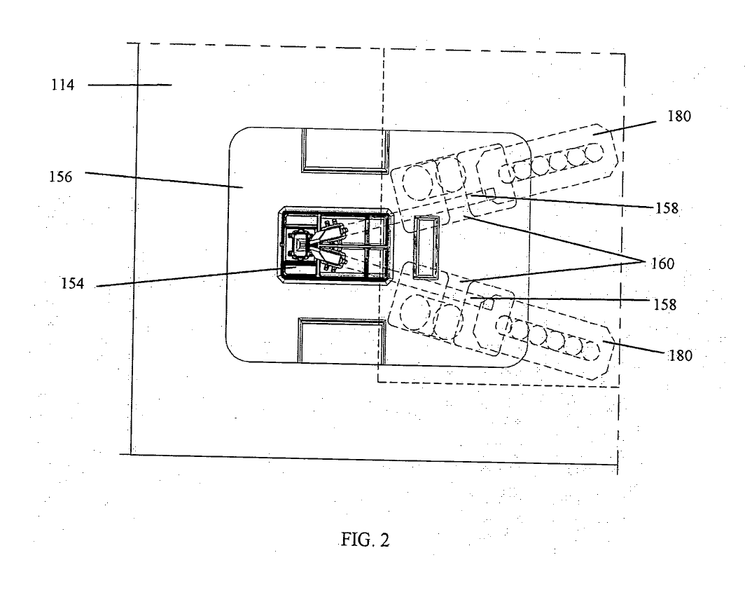

As seen in FIGS. 1A, 1B and 2, the angled-cavity forming core 158 is positioned at a 3-dimensional angle with respect to the opening and closing directions of the mold 100 or the molding insert 150. The angled-cavity forming core 158 is an elongate element that is shaped and dimensioned to extend into the mold cavity during the process of molding and to retract after the product has cooled and solidified enough for the product 102 and angled-cavity 104 to take shape. As shown in FIG. 1A or 1B, translation of the angled-cavity forming core 158 is provided by fixing the angled-cavity forming core 158 on a holder 160, with the holder 160 being disposed to slide with respect with the core insert 154 so that it is biased with a spring 162 against the core insert 154. Although not apparently shown in FIGS. 1A and 1B, the spring 162 is an extension spring and the angled-cavity forming core 158 is thus biased to retract to its un-activated position. With this embodiment, the driving mechanism for the angled-cavity forming core 158 is provided by a linear transfer actuator 180, which is actuated by the closing of the mold 100 halves. The arrows in FIGS. 1A and 1B indicate translations of the angled-cavity forming core 158 and holder 160 with the closing and opening of the mold 100. When the mold 100 is opened, the spring 162 restores the linear transfer actuator 180 to its un-actuated or home position. In use the sliding surfaces of the holder 160 and angled-cavity forming core 158 are oiled or greased to reduce friction, mechanical wear/tear and corrosion.

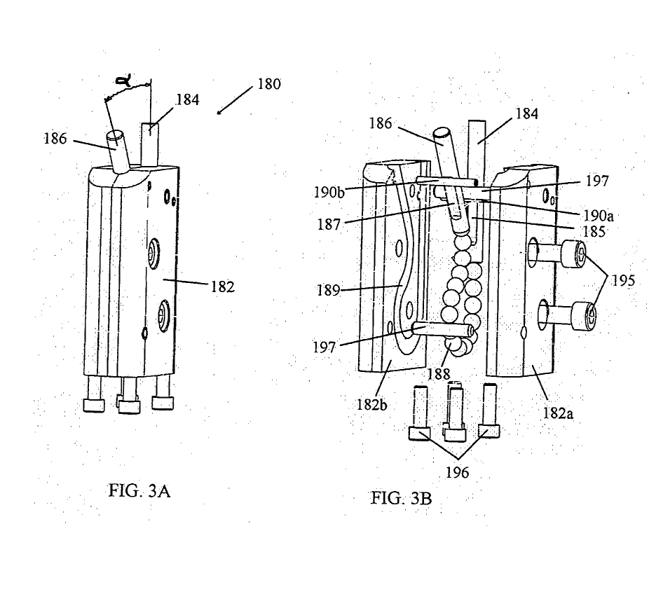

Referring to FIGS. 3A and 3B, the linear transfer actuator 180 comprises a body 182, a drive pin 184, a driven pin 186 and a system of balls 188 filling a groove 189 and connecting the drive pin 184 to the driven pin 186. As shown, the drive pin 184 and driven pin 186 are disposed at an angle, alpha, to each other, and the body 182 is made up of two halves 182a, 182b. Also as shown, screws 195 are used to hold the two halves 182a, 182b of the body together whilst screws 196 are used to mount the body 182 to the mold 100 directly to the core plate 116 or indirectly via a sub-back plate 118a; it is possible to dispense with the use of screws 196 by clamping the body 182 between two of the component mold plates. In use, portions of the drive and driven pins 184, 186 disposed inside the body 182 are fitted in bores to slide or reciprocate according to the length of the angled-cavity 104 or the required stroke of the angled-cavity forming core 158 with respect to the core insert 154. When the drive pin 184 is actuated, the actuating force is biased against the spring 162 and the drive pin 184 comes into mechanical contact with the driven pin 186 through the series of balls 188. In this way, translation of the drive pin 184 is transmitted into an equal displacement of the driven pin 186 but with a change of direction of translation. An advantage of the linear transfer actuator 180 is that it is simple to make and easy to re-configure with any angle, alpha, between the drive and drive pins. In addition, it is also compact in size, as seen in FIG. 2. Due to its compact size, the mold 100 can be configured with more molding stations per unit area when compared to molds employing the convention drive mechanisms. Invariably, the mold 100 employing the linear transfer actuator 180 of the present invention is comparatively lower in cost but higher in molding efficiency and throughput.

As shown in FIG. 3B, the portion of the drive pin 184 disposed inside the body 182 has a longitudinal flat surface 185 being formed parallel to the longitudinal axis of the drive pin 184. When the linear transfer actuator 180 is assembled, the flat surface 185 cooperates with a stopper pin 190a to prevent the drive pin 184 from being inadvertently displaced out of the body 182. Alternatively or in addition, a similar longitudinal flat surface 187 formed on the driven pin 186 is arranged to cooperate with a stopper pin 190b. To ensure that displacements of the drive or driven pins are not inhibited, strokes of movement of the flat surfaces 185, 187 against the respective stopper pins 190a, 190b must be more that the stroke required of the angled-cavity forming core 158. To ensure accurate alignment of the body halves 182a, 182b, two dowel pins 197 are provided.

As shown in FIG. 2, the plane along the angled-cavity forming core 158 is parallel to a plane through the middle of the linear transfer actuator 180. In addition, arranging the angled-cavity forming core 158 on the core insert 154 separately from the linear transfer actuator 180 allows only the angled-cavity forming core or core insert 154 to be replaced in a design change, thereby lowering the cost of using the mold of the present invention. In another embodiment, it is possible to align the plane of the angled-cavity forming core 158 at an angle with that of the linear transfer actuator 180; an advantage of this arrangement is that the mounting faces and mounting holes on the core plate 116 for connection with the actuator body 182 are orthogonally formed; the core plate 116 is relatively big and thus heavy, and the mounting faces and holes being orthogonally formed do not incur extra set-up cost. In yet another embodiment, it is possible to align the longitudinal axis of the angled-cavity forming core 158 with that of the driven pin 186; with this embodiment, it is further possible to make the angled-cavity forming core 158 integral with the driven pin 186 and doing away with the holder 160. In the embodiment without the holder 160, the biasing spring 162 acts directly on the angled-cavity forming core 158, drive or driven pin 184, 186.

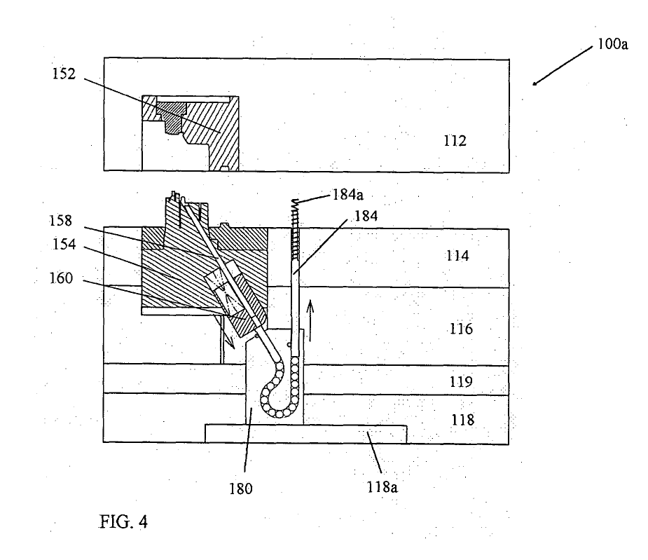

FIG. 4 shows a variation 100a of the mold shown in FIG. 1A. As shown in FIG. 4, the mold 100 and mold insert 150 are similar to those of the above embodiment except that the actuating end of the drive pin 184 has a step and the drive pin 184 is biased with a spring 184a. In use, the spring 184a is provided to take up accumulated deviations and tolerances, for example, of the groove 189, balls 188, holder 160 and so on. Preferably, the spring 184a is stiffer than the spring 162; this is to ensure that the angled-cavity forming core 158 is fully extended when the mold 100a is closed.

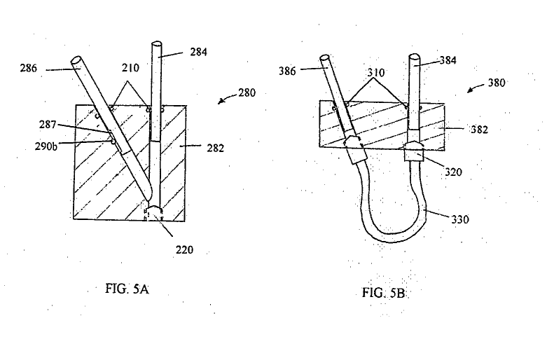

FIG. 5A shows a linear transfer actuator 280 according to another embodiment of the present invention. As shown in FIG. 5A, the linear transfer actuator 280 comprises of an actuator body 282, drive and driven pins 284, 286 with portions being operable to fit and slide inside the actuator body 282, just like the above embodiment, except that that the slide portions of the drive and driven pins are longer to accommodate a respective seal 210 and stroke length. The bores receiving the drive and driven pins 284, 286 intersect each other and they are filled with an incompressible fluid, such as, self-lubricating oil or grease through a nipple 220. In another embodiment, the bores receiving the drive and driven pins 284, 286 need not be very long but sufficiently long enough to accommodate the seal 210, stroke length and longitudinal flats 285, 287 (285 is not shown) and an interconnecting channel 230 (not shown) is provided for fluid path communication between the drive and driven pins 284, 286.

FIG. 5B shows a linear transfer actuator 380 according to another embodiment of the present invention. As shown in FIG. 5B, the linear transfer actuator 380 is similar to that of the previous embodiment 280 except that the actuator body 382 is thinner and the bores for receiving the drive and driven pins 384, 386 are shorter such that the bores are in fluid communication via a tube 330.

While specific embodiments have been described and illustrated, it is understood that many changes, modifications, variations and combinations thereof could be made to the present invention without departing from the scope of the present invention. For example, the longitudinal flat surfaces on the drive and driven pins may not be provided but the drive or driven pin may have a step, the shoulder of which is used to prevent the pin from being inadvertently displaced out of the actuator body. In another example, the drive pin may be actuated independently by an external means, such as, a solenoid or a fluid cylinder; this embodiment is useful when the angled-cavity forming core 158 is employed to place an insert into the mold cavity during a first stage molding and the angled-cavity forming core 158 is then retracted before a second stage molding is completed and the mold plates are opened.

1. A 3-dimensional angled cavity forming apparatus comprising:
an actuator body having two bores disposed axially at an angle to each other;
a drive pin and a driven pin separately disposed in the two bores so that the drive and driven pins are slidably guided for reciprocation in the respective bore; wherein a portion of the drive or driven pin disposed inside the actuator body has a longitudinal flat formed parallel to the longitudinal axis of the relevant pin;
a stopper pin disposed in the actuator body to cooperate with the longitudinal flat formed on the drive or driven pin;
a free end of the driven pin is configured as a cavity forming core in association with a mold insert and defines a 3-dimensional cavity within the mold insert; and
a channel of gradual changing direction for communicating between the two bores, with the channel being filled with an incompressible material so that when the drive pin is axially displaced, displacement of the drive pin is transmitted axially to the driven pin.

2. (canceled)

3. (canceled)

4. An apparatus according to claim 1, wherein the incompressible material comprises a series of metal balls.

5. An apparatus according to claim 1, wherein the incompressible material is oil or grease.

6. An apparatus according to claim 5, further comprising a seal disposed between the drive or driven pin and the actuator body to prevent the oil or grease from leaking out.

7. (canceled)

8. An apparatus according to claim 1, wherein the cavity forming core is retracted before the mold supporting the mold insert is opened.

9. An apparatus according to claim 8, wherein the cavity forming core is separate from the driven pin such that an end of the cavity forming core adjacent the driven pin is journaled in a holder and the holder is operable to slide with respect to the mold insert.

10. An apparatus according to claim 9, further comprising a compression spring disposed to bias the holder against the mold insert, so that the cavity forming core is retracted from the mold cavity before the mold is opened, and the cavity forming core is inserted into the mold cavity after the mold is closed.

11. An apparatus according to claim 9, wherein the cavity forming core is disposed at an angle to the driven pin.

12. An apparatus according to claim 8, wherein the cavity forming core is configured to place an insert during molding.

13. An apparatus according to claim 10, wherein the end of the drive pin adjacent the mold opening has a spring to take up dimensional deviations and tolerances accumulated along the motion transfer path.

14. A method for forming a 3-dimensional angled-cavity in a molded product, the method comprising:
transferring translation of a drive pin to a driven pin, wherein the drive and driven pins are disposed at an angle to each other;
actuating the driven pin to drive an angled-cavity forming core into a mold cavity, wherein the angled-cavity forming core is disposed at a 3-dimensional angle in the mold cavity;
filling the mold cavity with a molten compound and allowing the molten compound to cool and to solidify for it to take the shape of the mold cavity and angled-cavity forming core; and
retracting the angled-cavity forming core and then opening the mold supporting the mold insert, which defines the mold cavity, to release a molded product.

15. A method according to claim 14, wherein the angled-cavity forming core is journaled in a holder and the holder is slidably disposed with respect to the mold insert defining the mold cavity.

16. A method according to claim 15, further comprises biasing the holder against the mold insert so that the angled-cavity forming core is retracted from the mold cavity when the mold is opened.

17. A method according to claim 14, wherein actuating the drive pin is carried out by closing the mold supporting the mold insert.

18. A method according to claim 14, wherein actuating the drive pin is carried out by a solenoid or a fluid cylinder.

19. An insert molding method comprising:
transferring translation of a drive pin to a driven pin of the angled-motion transfer apparatus as defined in claim 1;
actuating the driven pin to place an insert, which is disposed at an end of an angled-cavity forming core, into a mold cavity, wherein the angled-cavity forming core is disposed at a 3-dimensional angle in the mold cavity;
filling the mold cavity with a molten compound in a first molding step and allowing the molten compound to cool and to solidify for it to take the shape of the mold cavity and to support the insert;
releasing the insert from the end of the angled-cavity forming core and then retracting the angled-cavity forming core;
filling the cavity created by the retracted angled-cavity forming core with a molten compound in a second molding step and allowing the molten compounds to cool and harden; and
opening the mold supporting the mold insert to release a molded product.
